(19) United States
(12) Patent Application Publication
(10) Pub. No.: US 2014/0203161 A1
(43) Pub. Date: Jul. 24, 2014

(54) System for wall-mounting of objects

(71) Applicant: Harry Don Marley, JR., Rogers, AR (US)

(72) Inventor: Harry Don Marley, JR., Rogers, AR (US)

(21) Appl. No.: 13/694,947

(22) Filed: Jan. 22, 2013

(51) Int. Cl. A47G 1/16; F16M 13/02

(52) U.S. Cl. CPC A47G 1/1606; F16M 13/02
USPC 248/475.1; 248/205.1

(57) ABSTRACT

A system for wall-mounting an object for viewing comprising a wall hanger having lugs extending therefrom, and a one-piece back plate formed to mate with the wall hanger via keyhole openings. An optional pre-formed frame may be receptive of the object and the back plate, may be formed of wood, plastic, or metal, has an opening on the front side, and may be relieved at its rear side to provide a relief for receiving the object and optionally a pane of glass and the back plate. A spacer optionally may be included between the object and the back plate. The back plate is attached to the frame conventionally. Where the back plate is not fitted within the relief but extends outboard thereof, the frame may be further relieved locally to obviate interference of the frame with the lugs extending through the back plate.

### TECHNICAL FIELD

The present invention relates to systems for mounting objects on walls; and more particularly, to such systems comprising a wall-mounted component and a hanging object assembly component matable with the wall-mounted component.

### BACKGROUND OF THE INVENTION

Various systems are known in the art for mounting an object onto a wall.

For simplicity, the term “object” wherever used herein should be taken to mean any object, e.g., a pre-formed frame, a mirror, signage, art work, picture, painting, print, sculpture, cabinet, shelves, or the like, that is intended to be mounted (hung) on a vertical surface.

A prior art mirror-mounting system of particular interest is the Model M1500 Channel Frame Mirror available from Meek Mirrors, LLC, Ft. Smith, Ark., USA.

The Model M1500 system comprises a hanging mirror assembly including a float glass mirror, an expanded polystyrene backing sheet, and two (left and right) back plates each having a rolled edge, all captured by, but not attached directly to, a wrap-around metal channel frame formed from linear channel stock by cutting a 90° miter at appropriate locations for three corners, folding the channel stock at those corners, and riveting or screwing the channel ends together at the fourth corner. The system further comprises a wall hanger preferably in the form of an open square formed of sheet metal and having a plurality of lugs with heads extending from the wall hanger near each of the four corners of the square. Adjacent each lug is a precision-punched hole in the wall hanger for mounting the wall hanger to a wall via fasteners, such as screws. The lugs mate with an equal number of keyhole openings formed in the left and right back plates of the hanging mirror assembly. The hanging mirror assembly is hung on the wall hanger by positioning the hanging mirror assembly with the lugs extending through the respective keyhole openings in the back plates and sliding the hanging mirror assembly downwards to capture the lug heads at the narrow ends of the keyhole openings. A pivotable slotted locking tab on one of the back plates is provided with a string extending beyond the edge of the hanging mirror assembly; the string is pulled by an installer to pivot the tab to engage the slot with an adjacent lug under the lug head, thereby preventing the hanging mirror assembly from being raised and removed from the wall hanger. The string is then cut flush with the edge of the mirror assembly and discarded.

The hanging mirror assembly may be removed by insertion of a thin tool between the back plate and wall hanger, pivoting the locking tab out of locking engagement, raising the hanging mirror assembly, and pulling the hanging mirror assembly away from the wall to clear the lug heads.

The Model M1500 system is very useful for utilitarian installations of mirrors such as restrooms in offices, hotels, airport terminals, and the like. However, this prior art system has some shortcomings and limitations, and its use is not readily expanded to wall mounting of other types of objects to be hung on walls.

First, the mirror assembly is available only in metal frame and only as assembled in the factory, and is limited to mounting of mirrors. Wood framing cannot be substituted for metal framing in the prior art assembly scheme, in either the system factory or elsewhere, because in the final assembly step the continuous metal channel stock is folded around the mirror and back plate and is then connected to itself at the fourth corner.

Second, the system does not readily lend itself to framing or hanging of items other than the original mirror in the factory. For example, artwork typically is installed into empty frames at an assembly use site apart from the system manufacturing facility.

Third, the metal frame of the prior art system may not fit well with the intended decor of an installation.

What is needed in the art is an improved wall-mounting system wherein some of the functional wall hanging elements of the just-described prior art system are retained but the range of materials to be wall-mounted is expanded to include objects formed in one or more steps apart from the system assembly steps. Such objects may be frames pre-formed of wood, glass, plastic, rubber, metal, or combinations thereof, or may be objects to be mounted directly without framing.

It is a principal object of the present invention to provide a flexible system for mounting of objects to be hung on walls at sites of use.

It is a further object of the present invention to provide a simple system for non-removably mounting objects on walls.

### SUMMARY OF THE INVENTION

Briefly described, a system in accordance with the present invention for wall-mounting an object comprises a wall-mountable element such as prior art wall hanger and a hanging object assembly. Preferably, the hanging object assembly includes a pivortable locking tab in accordance with the prior art to render the assembly theft-resistant. The present system provides a simple, fast installation of a wall-hanging object that is theft-resistant and easy to install and remove.

In a first exemplary embodiment of a hanging object assembly to be mated with a prior art wall hanger, a frame formed of wood, plastic, glass, rubber, metal, or combinations thereof is first provided. Such a frame may be formed in accordance with any prior art. The frame has an opening on the front side surrounded by three or more side elements, preferably four. Each of the side elements, preferably although not necessarily, is relieved at its rear side to provide a relief for receiving the object and optionally a pane of glass and at least one back plate preferably but not necessarily formed as one piece. A spacer optionally may be included between the object and the back plate. The back plate is attached to the frame by any conventional apparatus, e.g., bead of silicone, adhesive, tape, glazier points, brads, screws, or the like to form a hanging assembly component of the present invention. Where the back plate/plates is/are not fitted within the relief but extend outboard thereof, the frame may be further relieved locally via a plurality of cavities to obviate interference of the frame with the lugs extending through the back plate(s).

In a second exemplary embodiment of an object assembly, an object to be wall mounted without a frame, such as a small cabinet or shelving, is relieved locally via cavities as in the first embodiment, and the back plate/plates is/are attached directly to the object as by screws, bolts, or adhesive to form a hanging assembly component of the invention.

### BRIEF DESCRIPTION OF THE DRAWINGS

The present invention will now be described, by way of example, with reference to the accompanying drawings, in which:

FIG. 1 is an exploded perspective drawing of a prior art theft-proof mirror mounting system;

FIG. 2 is a plan view of a wall hanger component of the prior art system shown in FIG. 1;

FIG. 3 is a plan view of two back plate components of the prior art system shown in FIG. 1;

FIG. 4 is a cross-sectional view of a mirror assembly component of the prior art system shown in FIG. 1;

FIG. 5 is an exploded side assembly view of the prior art system shown in FIG. 1;

FIG. 6 is a cross-sectional view of a first embodiment of a hanging object assembly component of a theft-proof object mounting system in accordance with the present invention;

FIG. 7 is a cross-sectional view of a second embodiment of a hanging object assembly component of a theft-proof object mounting system in accordance with the present invention;

FIG. 8 is a plan view of a one-piece back plate in accordance with the present invention; and

FIG. 9 is a cross-sectional view of a third embodiment of a hanging object assembly component of a theft-proof object mounting system in accordance with the present invention.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

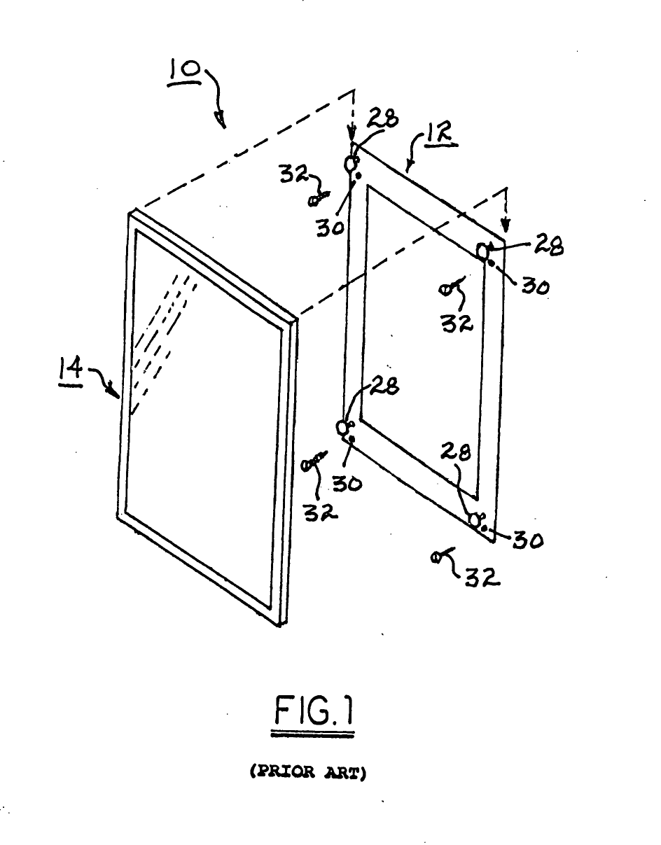

Referring to FIGS. 1 through 5, a prior art theft-proof mirror mounting system 10 comprises a wall-mountable element such as wall hanger 12 and a mirror assembly element 14.

Mirror assembly 14 includes a float glass mirror 16 having front and rear surfaces 18,20, an expanded polystyrene backing sheet 22, and two back plates 24, all captured in a wrap-around metal channel frame 26 formed from linear channel stock as described above for the Model M1500 system.

Wall hanger 12 comprises a wall hanger in the form of preferably an open square formed of sheet metal and having headed lugs 28 extending from the wall hanger near each of the four corners of the square. Adjacent each lug 28 is a precision-punched hole 30 in the wall hanger for mounting the wall hanger to a wall via screws 32. Lugs 28 mate with keyhole openings 34 formed in back plate 24 of mirror assembly 14.

In operation, wall hanger 12 is easily and quickly leveled and mounted, which leveling guarantees that the mirror assembly 14 will be level. Mirror assembly 14 is hung on wall hanger 12 by positioning mirror assembly 14 with lugs 28 extending through respective keyhole openings 34 and sliding mirror assembly 14 downwards to capture lug heads 36 at the narrow ends 38 of keyhole openings 34. A locking tab 40 having a slot 42 is pivotably mounted on back plate 24 and is provided with a string 44 extending beyond the edge of mirror assembly 14. String 44 is pulled by an installer to pivot locking tab 40 and thereby engage slot 42 with an adjacent lug 28 under its lug head, thereby preventing mirror assembly 14 from being raised and removed from wall hanger 12. String 44 is then cut flush with the edge of mirror assembly 14 and discarded. Preferably, string 44 is provided as a loop such that the entire string may be removed from locking tab 40 after the loop has been severed.

Mirror assembly 14 may be removed from wall hanger 12 by insertion of any thin tool (not shown) between back plate 24 and wall hanger 12, pivoting locking tab 40 out of locking engagement, raising mirror assembly 14, and pulling mirror assembly 14 away from the wall to clear lug heads 36.

Note that each back plate 24 comprises a turned edge portion 25 that includes a lower rest portion 27. Thus when assembled as shown in FIGS. 3 and 4, the spacing 29a between the back plates 24, and hence between the left and right keyhole openings 34, is controlled and precisely set by the width of mirror 16 to be correct for the spacing 29b between the left and right lugs 28 on the matable wall hanger 12 which is manufactured specifically for the dimensions of mirror 16.

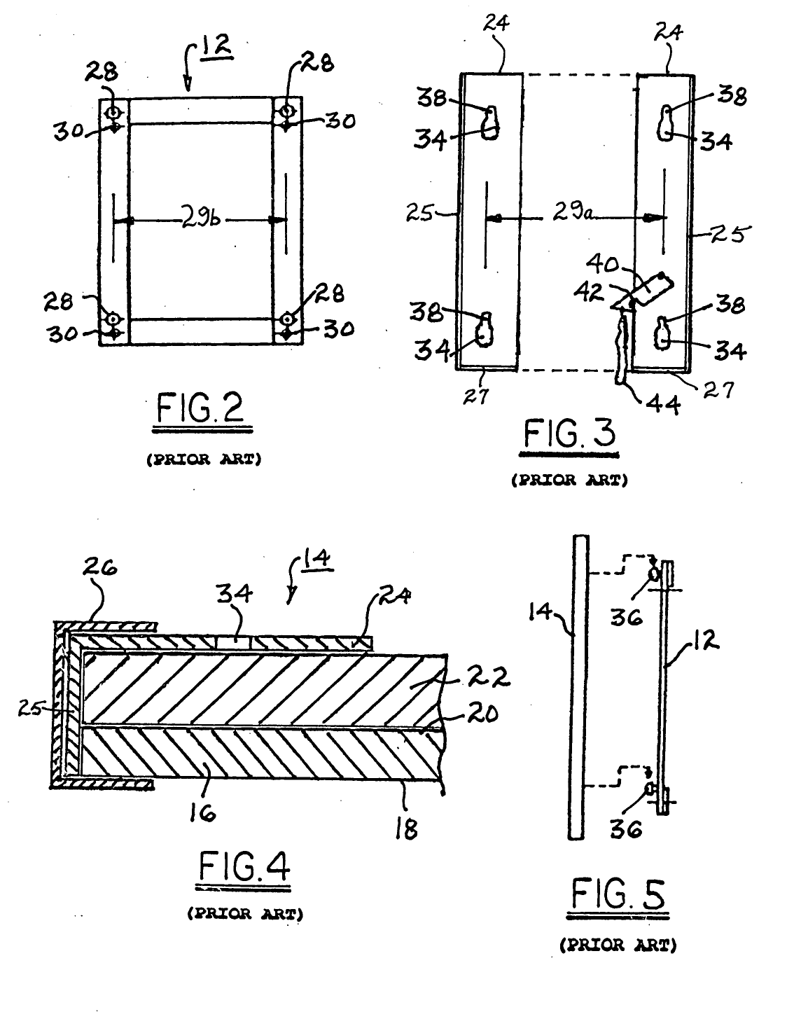

Referring to FIGS. 2, 6, and 8, a hanging object mounting system 110 in accordance the present invention comprises a wall-mountable element such as prior art wall hanger 12 and a first embodiment 114 of a hanging object assembly.

Hanging object assembly 114 comprises optionally a glass window 116, an object for display 117, a backing sheet 122, at least one back plate 124, and a pre-formed frame 126.

Frame 126 may be formed in accordance with any prior art and has an opening 150 on the front side to permit viewing of object 117 surrounded by three or more sides (not shown), preferably four. Each side is relieved at its rear side 127 to provide a relief 152 for receiving object 117, optional glass window 116, backing sheet 122, and one-piece back plate 124. Back plate 124 is attached to frame 126 by any conventional apparatus 154, e.g., bead of silicone, adhesive, tape, glazier points, brads, screws, or the like. Keyhole openings 34 are adjacent backing sheet 122 which may be compressible (e.g., expanded polystyrene) to admit lug heads 36 during mounting of hanging object assembly 114 onto wall plate 12. Alternatively, as shown in FIG. 6, one or more cavities 160 in backing sheet 122 may be provided to accommodate one or more lug heads 36 (FIG. 5).

It is a specific object of the present invention to minimize cost by employing a prior art wall plate 12 and a pre-formed frame 126 open to assembly of elements through the rear of the frame.

Note that each one-piece back plate 124, in contrast with the pair of prior art back plates 24, does not comprise a turned edge portion that includes a lower rest portion. Instead, one-piece back plate 124 is stamped from a sheet or formed by attaching strips together, and the spacing 129 between the left and right keyhole openings 134, is controlled and precisely set at the time of manufacture to be correct for the spacing 29b between the left and right lugs 28 on the matable wall hanger 12 (FIG. 2) which is manufactured specifically for the dimensions of one-piece back plate 124.

Thus in the present invention, and in distinct contrast to the prior art, the wall hanger 12 and the back plate 124 are manufactured as a matable set having identical and fixed spacing between the left and right lugs and the left and right keyhole openings. Thus, a matable set in accordance with the present invention may be applied to the hanging of a wide range of objects having differing width and height dimensions.

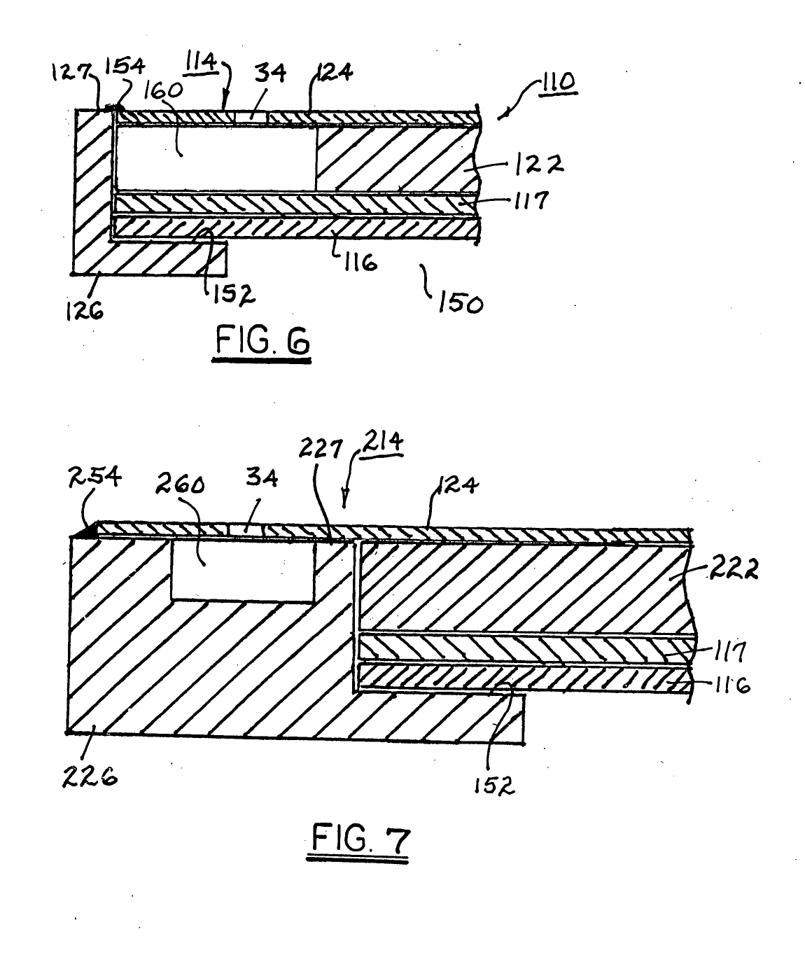

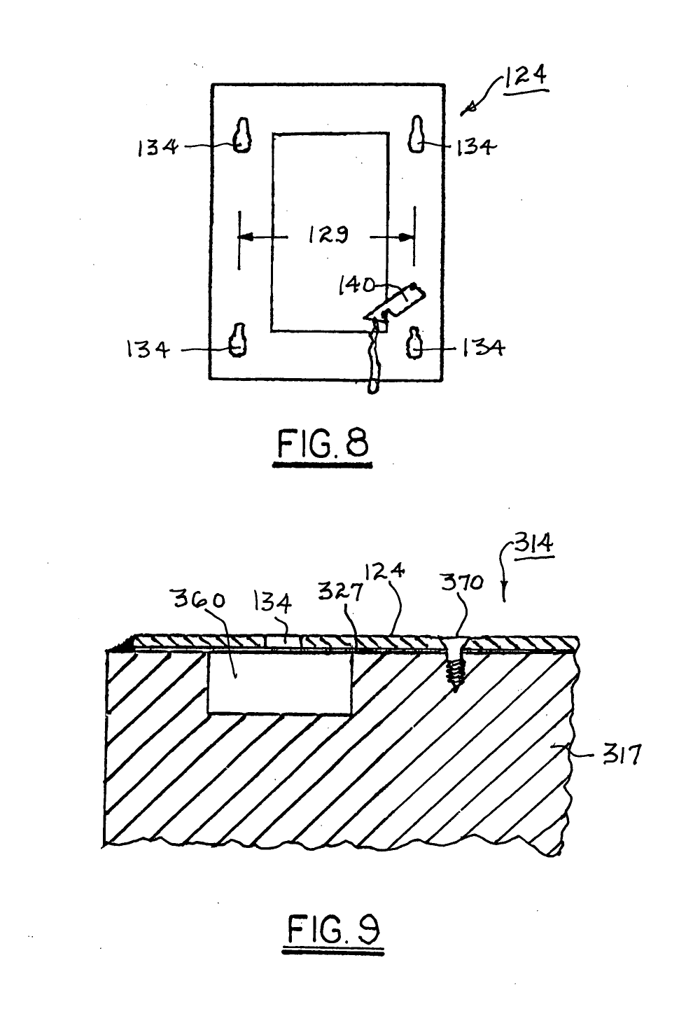

For a first example, and referring now to FIGS. 7 and 8, another embodiment 214 of a hanging object assembly is similar to embodiment 114 except that pre-formed frame 226 is large enough that keyhole openings 34 are adjacent frame 226 rather than backing sheet 222. Thus, a cavity 260 is provided in the rear surface 227 of frame 226 to accommodate lug heads 36 during mounting of object viewing assembly 214 onto wall plate 12. As in first embodiment 114, one-piece back plate 124 is attached to frame 226 by any conventional apparatus 254.

For a second example, and referring now to FIGS. 2, 8, and 9, in another embodiment 314 an object 317 to be hung does not require any framing but rather is mounted directly onto one-piece back plate 124 as by screws 370 or other conventional attachment means. As in embodiment 214, a cavity 360 is provided in the rear surface 327 of object 317 to accommodate lug heads 36 during mounting of hanging object assembly 314 onto wall plate 12.

In embodiments 114, 214, and 314, back plate 124 further comprises a pivotable locking tab 140.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An object mounting system, comprising:
a) a wall hanger having a plurality of headed lugs extending therefrom; and
b) a hanging object assembly including an object to be hung on said wall hanger,
wherein said hanging object assembly includes a back plate having a plurality of keyhole openings matable with said plurality of headed lugs, and
wherein said wall hanger and said back plate are manufactured as a matable set having identical and fixed spacing among said plurality of headed lugs and said plurality of keyhole openings.

2. An object mounting system in accordance with claim 1 wherein said object is selected from the group consisting of signage, artwork, mirror, picture, painting, print, sculpture, cabinet, and shelves.

3. An object mounting system in accordance with claim 1 wherein said back plate is selected from the group consisting of a one-piece back plate and a two-piece back plate.

4. An object mounting system in accordance with claim 1 wherein said back plate includes a pivotable locking tab.

5. An object mounting system in accordance with claim 1 wherein said hanging object assembly further comprises a pre-formed frame.

6. An object mounting system in accordance with claim 5 wherein said pre-formed frame is formed from a material selected from the group consisting of wood, plastic, metal, glass, rubber, and combinations thereof.

7. An object mounting system in accordance with claim 5 wherein said pre-formed frame includes a relief formed in the rear thereof for receiving said object.

8. An object mounting system in accordance with claim 7 wherein said back plate is receivable within said relief.

9. An object mounting system in accordance with claim 7 wherein said back plate extends over a rear surface of said pre-formed frame, and wherein a cavity is formed in said rear surface.

10. (canceled)

11. (canceled)

12. A method for forming a hanging object assembly including a wall hanger having a plurality of headed lugs extending therefrom, comprising the steps of:
a) providing a back plate having a plurality of keyhole openings matable with said plurality of headed lugs;
b) providing a pre-formed frame;
b) forming a relief in a rear surface of said frame;
c) placing said object within said relief;
d) installing said back plate onto said frame to capture said object within said frame; and
e) securing said back plate to said frame.

13. A method in accordance with claim 12 wherein said back plate is accommodated within said relief.

14. A method in accordance with claim 12 wherein said back plate extends over a portion of said rear surface, further comprising the step of forming a cavity in said rear surface.

15. A method in accordance with claim 12 comprising the further step of installing a sheet of glass within said relief.

16. (canceled)

17. A method in accordance with claim 12 wherein said back plate is selected from the group consisting of a one-piece back plate and a two-piece back plate.

18. (canceled)

19. (canceled)
